(19) United States
(12) Patent Application Publication
(10) Pub. No.: US 2026/0267112 A1
(43) Pub. Date: Sep. 10, 2026

(54) CAMERA MODULE

(71) Applicant: SAMSUNG ELECTRO-MECHANICS CO., LTD., Suwon-si (KR)

(72) Inventor: Young An CHOI, Suwon-si (KR)

(73) Assignee: SAMSUNG ELECTRO-MECHANICS CO., LTD., Suwon-si (KR)

(21) Appl. No.: 19/457,624

(22) Filed: Jan. 23, 2026

(30) Foreign Application Priority Data
Mar. 10, 2025 (KR) 10-2025-0030785

(51) Int. Cl. G02B 7/02; G02B 1/04; G03B 17/12

(52) U.S. Cl. CPC G02B 7/028; G02B 1/041; G02B 7/021; G03B 17/12; G03B 2217/002

(57) ABSTRACT

A camera module includes a first barrel configured to accommodate a first lens group; and a second barrel configured to accommodate a second lens group and accommodated within the first barrel. A first inner surface of the first barrel and a second outer surface of the second barrel are configured to contact each other at a first connection point or a second connection point.

### CROSS-REFERENCE TO RELATED APPLICATIONS

This application claims the benefit under 35 USC 119(a) of Korean Patent Application No. 10-2025-0030785 filed on March 10, 2025, in the Korean Intellectual Property Office, the entire disclosure of which is incorporated herein by reference for all purposes.

### BACKGROUND

### 1. Field

The present disclosure relates to a camera module capable of minimizing optical performance degradation caused by high temperatures.

### 2. Description of the Background

A camera module may include at least one lens. In general, the lens of the camera module may be formed of a glass material. A small-sized camera module may be mounted in a portable electronic device, on a vehicle bumper, or the like. Such a camera module is required to be miniaturized and lightweight, and may thus include a plastic lens. However, the plastic lens is prone to deformation or damage caused by high temperatures. In another example, the plastic lens may expand under high-temperature conditions, thereby changing its predetermined aligned position and degrading the optical performance of the camera module. In another example, the plastic lens may accumulate thermal stress without being able to expand inside a metal barrel, and may break at a certain point, thereby causing the camera module to completely lose its function.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a first barrel configured to accommodate a first lens group; and a second barrel configured to accommodate a second lens group and accommodated within the first barrel. A first inner surface of the first barrel and a second outer surface of the second barrel are configured to contact each other at a first connection point or a second connection point.

The first barrel and the second barrel may be composed of materials having different coefficients of linear expansion.

The second lens group may include a glass lens and a plastic lens.

The second lens group may include at least one glass lens, and the glass lens may be disposed most closely to the first connection point or the second connection point.

At the first connection point, the first inner surface may have a polygonal cross-sectional shape, and the second outer surface may have a circular cross-sectional shape.

At the first connection point, the first inner surface may have a circular cross-sectional shape, and the second outer surface may have a polygonal cross-sectional shape.

A buffer space, in which the first inner surface and the second outer surface are not in contact with each other, may be formed between the first connection point and the second connection point.

In the second connection point, the first barrel and the second barrel may be screw coupled.

In another general aspect, a camera module includes a first barrel configured to accommodate a first lens group; a second barrel configured to accommodate a second lens group and accommodated within the first barrel; and protrusions extending from an outer surface of the second barrel toward an inner surface of the first barrel.

The protrusions may be disposed at intervals around an optical axis of the second barrel.

The protrusions may be disposed at intervals along a length direction of the second barrel.

A length of the protrusion in an optical-axis direction may be equal to or greater than a rib thickness of a proximal lens disposed most closely to the protrusion in the second lens group.

The second lens group may include at least one glass lens, and the glass lens may be disposed most closely to the protrusion.

A buffer space configured to accommodate expansion deformation of the second lens group may be disposed between the first barrel and the second barrel.

The second lens group may include a plastic lens, and the plastic lens may be disposed adjacent to the buffer space.

Other features and aspects will be apparent from the following detailed description, the drawings, and the claims.

### BRIEF DESCRIPTION OF DRAWINGS

FIG. 1 is a configuration diagram of a camera module according to an example embodiment of the present disclosure.

FIGS. 2 and 3 are cross-sectional views of the camera module illustrated in FIG. 1.

FIG. 4 is an enlarged view of the camera module illustrated in FIG. 1.

FIG. 5 is a configuration diagram of a camera module according to an example embodiment of the present disclosure.

FIGS. 6 and 7 are cross-sectional views of the camera module illustrated in FIG. 5.

FIG. 8 is an enlarged view of the camera module illustrated in FIG. 5.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

A camera module according to an aspect of the present disclosure may include a plurality of barrels. For example, the camera module according to this aspect may include a first barrel and a second barrel. The camera module, according to an aspect, may include a plurality of lens groups. For example, the camera module according to this aspect may include a first lens group accommodated within the first barrel and a second lens group accommodated in the second barrel. The first barrel and the second barrel may be uniquely coupled to each other. For example, the first barrel may be formed to accommodate the second barrel therein. In another example, the first barrel and the second barrel may come into line-contact with each other at a plurality of points. In a specific example, the first barrel and the second barrel may come into contact with each other at a first connection point or a second connection point.

A camera module according to another aspect of the present disclosure may include a plurality of barrels. For example, the camera module according to this aspect may include a first barrel and a second barrel. The camera module, according to an aspect, may include a plurality of lens groups. For example, the camera module according to this aspect may include a first lens group accommodated within the first barrel and a second lens group accommodated in the second barrel. The first barrel and the second barrel may be uniquely coupled to each other. For example, the first barrel may be formed to accommodate the second barrel therein. The first barrel or the second barrel may include at least one protrusion. In an example, the first barrel may include a protrusion extending from an inner surface of the first barrel toward an outer surface of the second barrel. In another example, the second barrel may include a protrusion extending from the outer surface of the second barrel toward the inner surface of the first barrel.

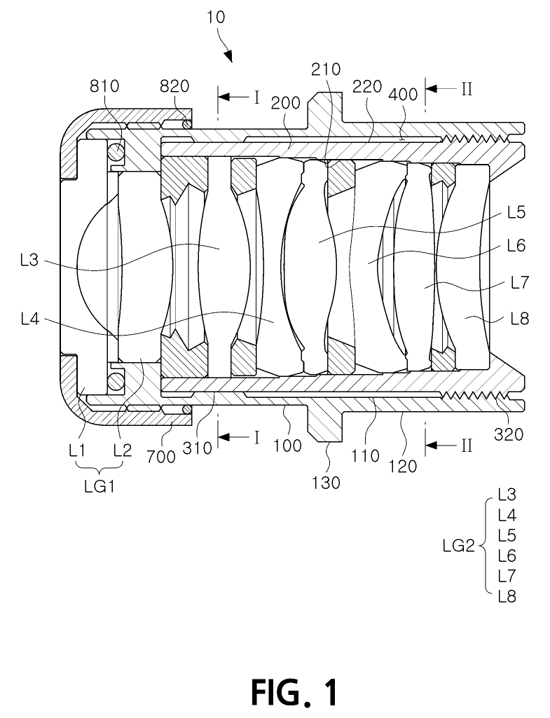

Hereinafter, an example embodiment of the present disclosure will be described in detail with reference to the accompanying exemplary drawings. First, a camera module according to an example embodiment will be described with reference to FIGS. 1 to 4.

A camera module 10 according to this example embodiment may include a first barrel 100, a second barrel 200, a first lens group LG1, and a second lens group LG2. However, the configuration of the camera module 10 is not limited to the above-described members. In an example, the camera module 10 may further include a cover member 700 and sealing members 810 and 820. In another example, the camera module 10 may further include protective glass, a spacing-maintaining member, and an image sensor.

The first barrel 100 may be formed to accommodate another member of the camera module 10. For example, the first barrel 100 may be formed to accommodate the second barrel 200. In a specific example, the first barrel 100 may be formed to accommodate all portions of the second barrel 200 from one end to the other end therein.

The first barrel 100 may be formed to accommodate at least one lens. For example, the first barrel 100 may accommodate the first lens group LG1 therein. The first barrel 100 may facilitate the installation and mounting of the camera module 10. For example, the first barrel 100 may include a flange 130 formed to be easily coupled to an exterior material of a vehicle, a case of an electronic device, or the like. The flange 130 may be disposed on a first outer surface 120 of the first barrel 100.

The second barrel 200 may be coupled to the first barrel 100. For example, the second barrel 200 may be coupled to the first barrel 100 while being accommodated within the first barrel 100. The second barrel 200 may be formed to accommodate at least one lens. For example, the second lens group LG2 may be accommodated inside a second inner surface 210 of the second barrel 200. The second barrel 200 may be formed of a material different from that of the first barrel 100, or may have a different coefficient of linear expansion from that of the first barrel 100. For example, the first barrel 100 may be formed of a metal material, and the second barrel 200 may be formed of a plastic material.

The first lens group LG1 may include at least one lens. For example, the first lens group LG1 may include a first lens L1 and a second lens L2. At least one of the first lens L1 and the second lens L2 may have refractive power. For example, the first lens L1 may have negative refractive power, and the second lens L2 may have positive refractive power. However, the refractive powers of the first lens L1 and the second lens L2 are not limited to the above-described example. For example, the first lens L1 may have substantially no refractive power. In a specific example, the first lens L1 may have both an object-side surface and an image-side surface that are planar. The first lens L1 and the second lens L2 may each be formed of a material resistant to external impact and heat. For example, the first lens L1 and the second lens L2 may each be formed of glass.

The second lens group LG2 may include at least one lens. For example, the second lens group LG2 may include a third lens L3, a fourth lens L4, a fifth lens L5, a sixth lens L6, a seventh lens L7, and an eighth lens L8. However, the configuration of the second lens group LG2 is not limited to the above-described lenses. In an example, the second lens group LG2 may include five or fewer lenses or seven or more lenses. The second lens group LG2 may include heterogeneous lenses. For example, the second lens group LG2 may include at least one glass lens L3 or L8 and at least one plastic lens L4, L5, L6, or L7.

The first barrel 100 and the second barrel 200 may be formed to come into contact with each other at a plurality of points. For example, the first barrel 100 and the second barrel 200 may be formed to come into contact with or be coupled to each other at a first connection point 310 or a second connection point 320.

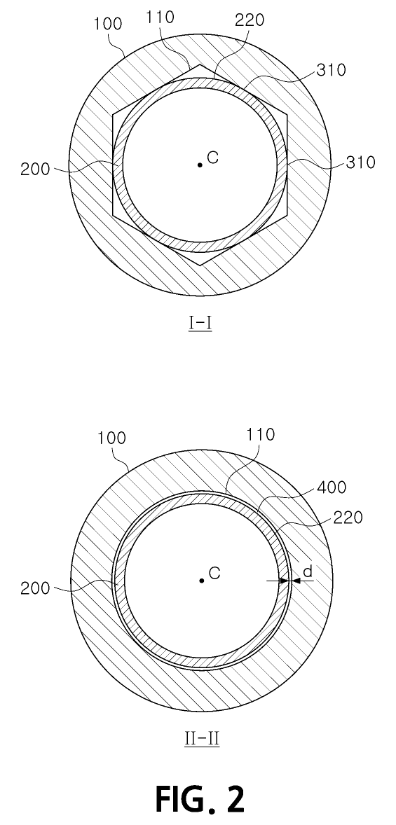

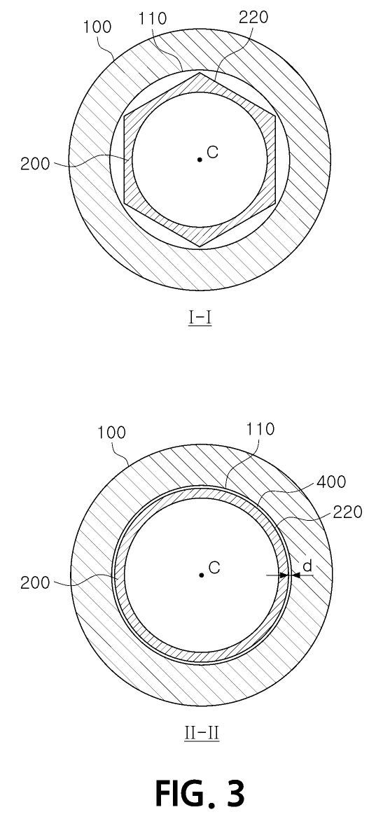

The first connection point 310 may be formed to achieve line contact or point contact between the first barrel 100 and the second barrel 200. In an example, as illustrated in FIG. 2, at the first connection point 310, a first inner surface 110 of the first barrel 100 may have a polygonal cross-sectional shape, and a second outer surface 220 of the second barrel 200 may have a circular cross-sectional shape inscribed in the first inner surface 110. In another example, as illustrated in FIG. 3, at the first connection point 310, the first inner surface 110 of the first barrel 100 may have a circular cross-sectional shape, and the second outer surface 220 of the second barrel 200 may have a polygonal cross-sectional shape inscribed in the first inner surface 110.

The first connection point 310 may be formed at a unique position. In an example, the first connection point 310 may be formed at a position adjacent to the glass lens L3 of the second lens group LG2. In another example, the first connection point 310 may be formed at a position closest to the glass lens L3 among the lenses of the second lens group LG2.

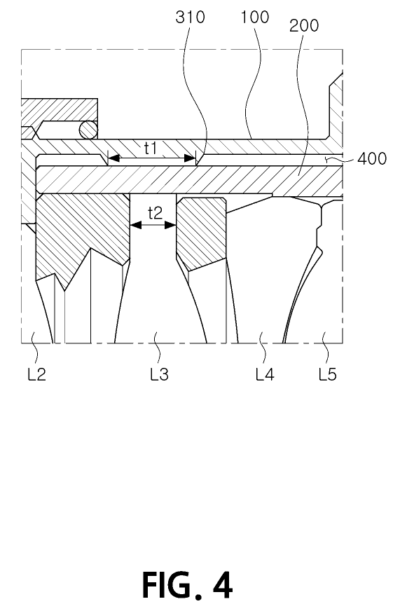

As illustrated in FIG. 4, the first connection point 310 may have a unique relationship with the glass lens L3 disposed most closely thereto. For example, a length t1 of the first connection point 310 in an optical-axis direction may be equal to or greater than a rib thickness t2 of the adjacent glass lens L3.

The second connection point 320 may enable firm coupling between the first barrel 100 and the second barrel 200. In an example, the second connection point 320 may be formed by screw coupling between the first barrel 100 and the second barrel 200. The second connection point 320 may be formed at a unique position. In an example, the second connection point 320 may be formed at a position adjacent to the glass lens L8 of the second lens group LG2.

A buffer space 400, in which the inner surface 110 of the first barrel 100 and the outer circumferential surface 220 of the second barrel 200 are not in contact with each other, may be formed between the first connection point 310 and the second connection point 320. The buffer space 400 may be formed at a unique position. For example, the buffer space 400 may be formed between the first barrel 100 and the second barrel 200 at a portion adjacent to the plastic lenses L4, L5, L6, and L7 of the second lens group LG2. The buffer space 400 may have a predetermined size. For example, a distance d from the inner surface 110 of the first barrel 100 to the outer circumferential surface 220 of the second barrel 200 at the position where the buffer space 400 is formed may be determined in consideration of the thermal expansion strain and thermal deformation amount of each of the plastic lenses L4, L5, L6, and L7.

The camera module 10 configured as described above may include the first barrel 100 including the plurality of glass lenses and the second barrel 200 including the plurality of plastic lenses formed of different materials, and thus maintain stable optical performance even under high-temperature conditions. In addition, the camera module 10 according to this example embodiment may have the buffer space 400 formed between the first connection point 310 and the second connection point 320, and thus effectively alleviate or absorb expansion deformation and expansion stress of each of the plastic lenses L4, L5, L6, and L7.

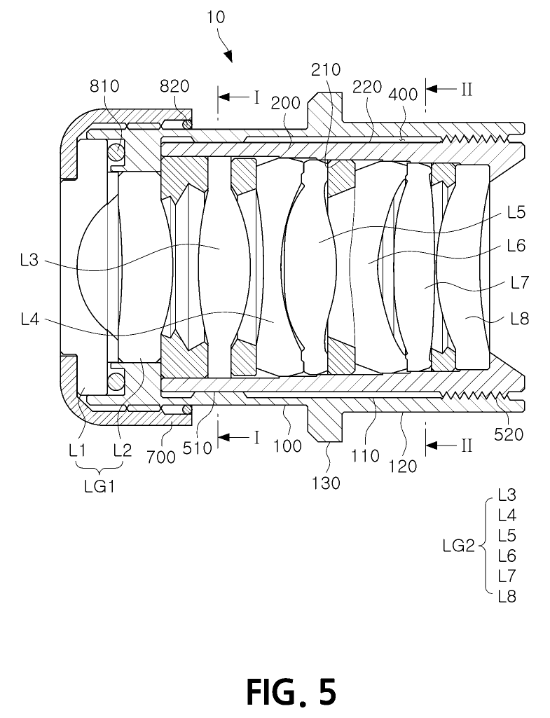

Next, a camera module according to another example embodiment will be described with reference to FIGS. 5 to 8.

A camera module 12 according to this example embodiment may include a first barrel 100, a second barrel 200, a first lens group LG1, and a second lens group LG2. However, the configuration of the camera module 12 is not limited to the above-described members. In an example, the camera module 12 may further include a cover member 700 and sealing members 810 and 820. In another example, the camera module 12 may further include protective glass, a spacing-maintaining member, and an image sensor.

The first barrel 100 may be formed to accommodate another member of the camera module 12. For example, the first barrel 100 may be formed to accommodate the second barrel 200. In a specific example, the first barrel 100 may be formed to accommodate all portions of the second barrel 200 from one end to the other end therein.

The first barrel 100 may be formed to accommodate at least one lens. For example, the first barrel 100 may accommodate the first lens group LG1 therein. The first barrel 100 may facilitate the installation and mounting of the camera module 12. For example, the first barrel 100 may include a flange 130 formed to be easily coupled to an exterior material of a vehicle, a case of an electronic device, or the like. The flange 130 may be disposed on a first outer surface 120 of the first barrel 100.

The second barrel 200 may be coupled to the first barrel 100. For example, the second barrel 200 may be coupled to the first barrel 100 while being accommodated within the first barrel 100. The second barrel 200 may be formed to accommodate at least one lens. For example, the second lens group LG2 may be accommodated inside a second inner surface 210 of the second barrel 200. The second barrel 200 may be formed of a material different from that of the first barrel 100, or may have a different coefficient of linear expansion from that of the first barrel 100. For example, the first barrel 100 may be formed of a metal material, and the second barrel 200 may be formed of a plastic material.

The first lens group LG1 may include at least one lens. For example, the first lens group LG1 may include a first lens L1 and a second lens L2. At least one of the first lens L1 and the second lens L2 may have refractive power. For example, the first lens L1 may have negative refractive power, and the second lens L2 may have positive refractive power. However, the refractive powers of the first lens L1 and the second lens L2 are not limited to the above-described example. For example, the first lens L1 may have substantially no refractive power. In a specific example, the first lens L1 may have both an object-side surface and an image-side surface that are planar. The first lens L1 and the second lens L2 may each be formed of a material resistant to external impact and heat. For example, the first lens L1 and the second lens L2 may each be formed of glass.

The second lens group LG2 may include at least one lens. For example, the second lens group LG2 may include a third lens L3, a fourth lens L4, a fifth lens L5, a sixth lens L6, a seventh lens L7, and an eighth lens L8. However, the configuration of the second lens group LG2 is not limited to the above-described lenses. In an example, the second lens group LG2 may include five or fewer lenses or seven or more lenses. The second lens group LG2 may include heterogeneous lenses. For example, the second lens group LG2 may include at least one glass lens L3 or L8 and at least one plastic lens L4, L5, L6, or L7.

The first barrel 100 and the second barrel 200 may be formed to come into contact with each other at a plurality of points. For example, at least one first protrusion 510 or at least one second protrusion 520 may be formed on the first barrel 100 or the second barrel 200. In a specific example, the first barrel 100 may include the first protrusion 510 extending from a first inner surface 110 of the first barrel 100 toward an outer surface 220 of the second barrel 200. In another specific example, the second barrel 200 may include the first protrusion 510 extending from the outer surface 220 of the second barrel 200 toward the first inner surface 110 of the first barrel 100. The first protrusion 510 and the second protrusion 520 may be formed at intervals along a length direction of the second barrel 200.

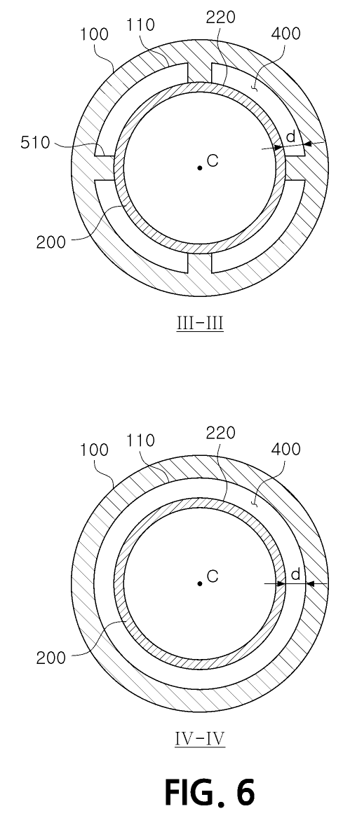

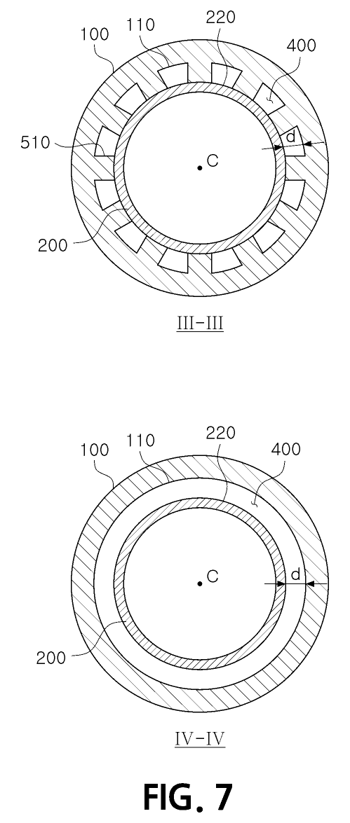

The first protrusion 510 may be formed to achieve partial contact between the first barrel 100 and the second barrel 200. In an example, as illustrated in FIGS. 6 and 7, the first protrusion 510 may be formed at predetermined intervals along the first inner surface 110 of the first barrel 100 or the second outer surface 220 of the second barrel 200. For reference, FIGS. 6 and 7 illustrate that four and twelve first protrusions 510 are formed around an optical axis C of the second barrel 200. However, the number of first protrusions 510 is not limited to four or twelve. In an example, three or fewer first protrusions 510 may be formed on the second outer surface 220 of the second barrel 200. In another example, five to eleven first protrusions 510 may be formed on the second outer surface 220, and thirteen or more first protrusions 510 may also be formed thereon.

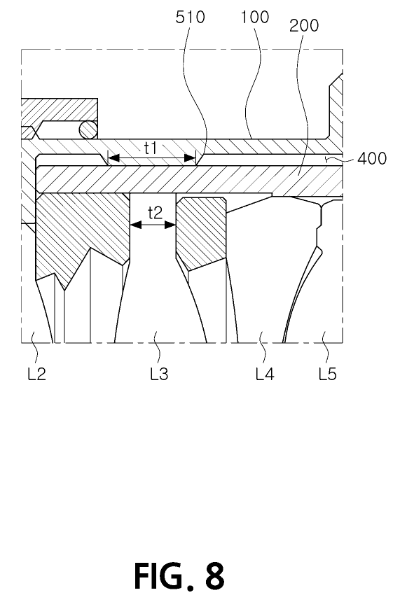

The first protrusion 510 may be formed at a unique position. In an example, the first protrusion 510 may be formed at a position adjacent to the glass lens L3 of the second lens group LG2. In another example, the first protrusion 510 may be formed at a position closest to the glass lens L3 among the lenses of the second lens group LG2. As illustrated in FIG. 8, the first protrusion 510 may have a unique relationship with the glass lens L3 disposed most closely thereto. For example, a length t1 of the first protrusion 510 in an optical-axis direction may be equal to or greater than a rib thickness t2 of the adjacent glass lens L3.

The second protrusion 520 may enable firm coupling between the first barrel 100 and the second barrel 200. In an example, the second protrusion 520 may be formed by screw coupling between the first barrel 100 and the second barrel 200. The second protrusion 520 may be formed at a unique position. In an example, the second protrusion 520 may be formed at a position adjacent to the glass lens L8 of the second lens group LG2.

A buffer space 400, in which the inner surface 110 of the first barrel 100 and the outer circumferential surface 220 of the second barrel 200 are not in contact with each other, may be formed between the first protrusion 510 and the second protrusion 520. The buffer space 400 may be formed at a unique position. For example, the buffer space 400 may be formed between the first barrel 100 and the second barrel 200 at a portion adjacent to the plastic lenses L4, L5, L6, and L7 of the second lens group LG2. The buffer space 400 may have a predetermined size. For example, a distance d from the inner surface 110 of the first barrel 100 to the outer circumferential surface 220 of the second barrel 200 at the position where the buffer space 400 is formed may be determined in consideration of the thermal expansion strain and thermal deformation amount of each of the plastic lenses L4, L5, L6, and L7.

The camera module 12 configured as described above may include the first barrel 100 including the plurality of glass lenses and the second barrel 200 including the plurality of plastic lenses formed of different materials, and thus maintain stable optical performance even under high-temperature conditions. In addition, the camera module 12 according to this example embodiment may have the buffer space 400 formed between the first protrusion 510 and the second protrusion 520, and thus effectively alleviate or absorb expansion deformation and expansion stress of each of the plastic lenses L4, L5, L6, and L7.

One or more embodiments may provide a camera module capable of alleviating optical performance degradation of the camera module caused by high temperatures.

As set forth above, the present disclosure may minimize the performance variation of the camera module caused by temperature changes.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a first barrel configured to accommodate a first lens group; and
a second barrel configured to accommodate a second lens group and accommodated within the first barrel,
wherein a first inner surface of the first barrel and a second outer surface of the second barrel are configured to contact each other at a first connection point or a second connection point.

2. The camera module of claim 1, wherein the first barrel and the second barrel are composed of materials having different coefficients of linear expansion.

3. The camera module of claim 1, wherein the second lens group comprises a glass lens and a plastic lens.

4. The camera module of claim 1, wherein the second lens group comprises at least one glass lens, and
the glass lens is disposed most closely to the first connection point or the second connection point.

5. The camera module of claim 1, wherein, at the first connection point, the first inner surface has a polygonal cross-sectional shape, and the second outer surface has a circular cross-sectional shape.

6. The camera module of claim 1, wherein, at the first connection point, the first inner surface has a circular cross-sectional shape, and the second outer surface has a polygonal cross-sectional shape.

7. The camera module of claim 1, wherein a buffer space, in which the first inner surface and the second outer surface are not in contact with each other, is formed between the first connection point and the second connection point.

8. The camera module of claim 1, wherein the second connection point is a screw coupling between the first barrel and the second barrel.

9. A camera module comprising:
a first barrel configured to accommodate a first lens group;
a second barrel configured to accommodate a second lens group and accommodated within the first barrel; and
protrusions extending from an outer surface of the second barrel toward an inner surface of the first barrel.

10. The camera module of claim 9, wherein the protrusions are disposed at intervals around an optical axis of the second barrel.

11. The camera module of claim 9, wherein the protrusions are disposed at intervals along a length direction of the second barrel.

12. The camera module of claim 9, wherein a length of the protrusion in an optical-axis direction is equal to or greater than a rib thickness of a proximal lens disposed most closely to the protrusion in the second lens group.

13. The camera module of claim 9, wherein the second lens group comprises at least one glass lens, and
the glass lens is disposed most closely to the protrusion.

14. The camera module of claim 9, wherein a buffer space configured to accommodate expansion deformation of the second lens group is disposed between the first barrel and the second barrel.

15. The camera module of claim 14, wherein the second lens group comprises a plastic lens, and
the plastic lens is disposed to be adjacent to the buffer space.
